(19) United States
(12) Patent Application Publication
(10) Pub. No.: US 2022/0030456 A1
(43) Pub. Date: Jan. 27, 2022

(54) First Network Node, First UE and Methods Performed Therein for Handling Communication

(71) Applicant: Telefonaktiebolaget LM Ericsson (PUBL), Stockholm (SE)

(72) Inventors: Mårten Sundberg, ÅRSTA (SE); David Astely, BROMMA (SE); Thomas Chapman, SOLNA (SE); Filip Barac, HUDDINGE (SE); Petter Ersbo, Knivsta (SE); Sebastian Faxér, STOCKHOLM (SE); Håkan Björkegren, TÄBY (SE)

(21) Appl. No.: 17/421,932

(22) PCT Filed: Jan. 13, 2020
(86) PCT No.: PCT/SE2020/050025

§ 371 Date: Jul. 9, 2021

Related U.S. Application Data
(60) Provisional application No. 62/791,044, filed on Jan. 11, 2019.

(51) Int. Cl. H04W 24/10; H04B 17/336; H04L 5/14

(52) U.S. Cl. CPC H04W 24/10; H04L 5/1469; H04B 17/336

(57) ABSTRACT

Embodiments herein relate to e.g. a method performed by a first network node (12) for handling communication of data of a first user equipment, UE, (10) in a communication network. The first network node initiates a measurement of interference from a second network node (13) towards the first network node, and/or from a second UE (10) of the second network node (13) towards the first UE of the first network node (12), wherein the measurement is based on a knowledge of time division duplex, TDD, configuration of the second network node (13), and wherein the first network node is operated by a different operator than the second network node.

### TECHNICAL FIELD

Embodiments herein relate to a first network node, a first user equipment (UE) and methods performed therein for communication. Furthermore, a computer program product and a computer readable storage medium are also provided herein. In particular, embodiments herein relate to handle, such as enable, communication within a communication network e.g. enabling transmissions in a serving cell.

### BACKGROUND

In a typical communication network, User equipments (UE), also known as wireless communication devices, mobile stations, stations (STA) and/or wireless devices, communicate via a Radio Access Network (RAN) to one or more core networks (CN). The RAN covers a geographical area which is divided into service areas or cell areas, with each service area or cell area being served by a network node such as a radio access node e.g., a Wi-Fi access point or a radio base station (RBS), which in some networks may also be denoted, for example, a NodeB, an eNodeB, or a gNodeB. A service area or cell is a geographical area where radio coverage is provided by the network node. The network node communicates over an air interface operating on radio frequencies with the UE within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks, and investigate enhanced data rate and radio capacity. In some RANs, e.g. as in UMTS, several network nodes may be connected, e.g., by landlines or microwave, to a controller node, such as a radio network controller (RNC) or a base station controller (BSC), which supervises and coordinates various activities of the plural network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the network nodes are directly connected to the EPC core network rather than to RNCs. In general, in E-UTRAN/LTE the functions of an RNC are distributed between the network nodes, e.g. eNodeBs in LTE, and the core network. As such, the RAN of an EPS has an essentially “flat” architecture comprising network nodes connected directly to one or more core networks, i.e. they are not connected to RNCs. To compensate for that, the E-UTRAN specification defines a direct interface between the network nodes, this interface being denoted the X2 interface.

Thus, wireless cellular networks are built up of cells, each cell defined by a certain coverage area of a network node (NN). The NN communicates with user equipment (UE) in the network wirelessly. The communication is carried out in either paired or unpaired spectrum. In case of paired spectrum, the downlink (DL) and uplink (UL) directions are separated in frequency, called Frequency Division Duplex (FDD). In case of unpaired spectrum, the DL and UL use the same spectrum, same frequency, called Time Division Duplex (TDD). As the name implies, the DL and UL are separated in the time domain, typically with a guard period (GP) between them. A GP serves several purposes. Most essentially, processing circuitry at the NN and the UE needs a sufficient time to switch between a transmission and a reception, however this is typically a fast procedure and does not significantly contribute to the requirement of the GP size. There is one GP at a DL-to-UL switch and one GP at an UL-to-DL switch, but since the GP at the UL-to-DL switch only needs to give enough time to allow the NN and the UE to switch between the reception and the transmission, and consequently typically is small, it is for simplicity neglected in the following description. The GP at the DL-to-UL switch, however, must be sufficiently large to allow a UE to receive a (time-delayed) DL grant scheduling the UL and transmit the UL signal with proper timing advance (compensating for the propagation delay) such that it is received in the UL part of the frame at the NN (in fact, the GP at the UL-to-DL switch is created with an offset to the timing advance). Thus, the GP should be larger than two times the propagation time towards a UE at the cell edge, otherwise, the UL and DL signals in the cell will interfere. Because of this, the GP is typically chosen to depend on the cell size such that larger cells, i.e. larger inter-site (within the site) distances, have a larger GP and vice versa.

Additionally, the GP reduces DL-to-UL interference between NNs by allowing a certain propagation delay between cells without having the DL transmission of a first NN enter the UL reception of a second NN. In a typical macro network, the DL transmission power can be on the order of 20 dB larger than the UL transmission power, and the pathloss between NNs, perhaps above roof top and in line of sight (LOS), may often be much smaller than the pathloss between NNs and UEs (in NLOS). Hence, if the UL is interfered by the DL of other cells, so called cross-link interference, the UL performance can be seriously degraded. Because of the large transmit power discrepancy between UL and DL and/or propagation conditions, cross-link interference (CLI) can be detrimental to system performance not only for the co-channel case (where DL interferes UL on the same carrier) but also for the adjacent channel case (where DL of one carrier interferes with UL on an adjacent carrier). Because of this, TDD macro networks are typically operated in a synchronized and aligned fashion where the symbol timing is aligned and a semi-static TDD UL/DL pattern is used which is the same for all the cells in the NW; by aligning UL and DL periods so that they do not occur simultaneously the thinking is to reduce interference between UL and DL Typically, operators with adjacent TDD carriers also synchronize their TDD UL/DL patterns to avoid adjacent channel cross-link interference.

The principle of applying a GP, at the DL-to-UL switch, to avoid DL-to-UL interference between NNs is shown in FIG. 1A where a victim NN (V) is being (at least potentially) interfered by an aggressor (A). The aggressor sending a DL signal to a device in its cell, the DL signal also reaching the victim BS (the propagation loss is not enough to protect it from the signals of A) which is trying to receive a signal from another terminal (not shown in the figure) in its cell. The signal has propagated a distance (d) and due to propagation delay, the experienced frame structure alignment of A at V is shifted/delayed τ second, proportional to the propagation distance d. As can be seen from the figure, although the DL part of the aggressor NN (A) is delayed, it does not enter the UL region of the victim (V) due to the GP used. The system design serves its purpose! As a side note, the aggressor DL signal does of course undergo attenuation, but may due to differences in transmit powers in terminals and NNs as well as propagation condition differences for NN-to-NN links and UE-to-NN links be very high relative to the received victim UL signal.

It could be noted that the terminology victim and aggressor is only used here to illustrate why typical TDD systems are designed as they are. The victim can also act as an aggressor and vice versa and even simultaneously since channel reciprocity exists between the NN.

The RAT next generation mobile wireless communication system (5G) or new radio (NR), supports a diverse set of use cases and a diverse set of deployment scenarios. The later includes deployment at both low frequencies (100s of MHz), similar to the RAT LTE today, and very high frequencies (mm waves in the tens of GHz).

Similar to LTE, NR uses OFDM (Orthogonal Frequency Division Multiplexing) in the DL (i.e. from a NN e.g. a gNB, eNB, or base station, to a user equipment or UE). The basic NR physical resource over an antenna port can thus be seen as a time-frequency grid as illustrated in Error! Reference source not found. FIG. 1B, where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by (15×2^{α}) kHz, α=0, 1, 2, 3 where 15 kHz is the basic (or reference) subcarrier spacing that is also used in LTE.

In the time domain, DL and UL transmissions in NR will be organized into equally-sized subframes of 1 ms each, similar to LTE. A subframe is further divided into multiple slots of equal duration. The slot length for subcarrier spacing Δf=(15×2^{α}) kHz is ½^{α} ms. There is only one slot per subframe at Δf=15 kHz and a slot consists of 14 OFDM symbols.

DL transmissions are dynamically scheduled, i.e., in each slot the network node transmits DL control information (DCI) about which UE data is to be transmitted to and which resource blocks in the current DL slot the data is transmitted on. This control information is typically transmitted in the first one or two OFDM symbols in each slot in NR. The control information is carried on the Physical Downlink Control Channel (PDCCH) and data is carried on the Physical Downlink Shared Channel (PDSCH). A UE first detects and decodes PDCCH and if a PDCCH is decoded successfully, it then decodes the corresponding PDSCH based on the decoded control information in the PDCCH.

In addition to PDCCH and PDSCH, there are also other channels and reference signals transmitted in the DL.

UL data transmissions, carried on Physical Uplink Shared Channel (PUSCH), are also dynamically scheduled by the network node by transmitting a DCI. In case of TDD operation, the DCI, which is transmitted in the DL region, always indicates a scheduling offset so that the PUSCH is transmitted in a slot in the UL region.

In TDD, some subframes/slots are allocated for UL transmissions and some subframes/slots are allocated for DL transmissions. The switch between DL (D) and UL (U) occurs in the so called special subframes (S) in LTE or called flexible slots in NR.

In LTE, seven different UL-DL configurations, also referred to as TDD configurations, are provided, see Table 1.

TABLE 1
LTE UL-DL configurations (from 36.211, Table 4.2-2,
v 15.0.0)

| UL-DL | DL-to-UL | | | | | | | | | | |
|---|---|---|---|---|---|---|---|---|---|---|---|
| configura- | Switch-point | Subframe number | | | | | | | | | |
| tion | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

The size of the GP, and hence the number of symbols for DwPTS (DL transmission in a special subframe) and UpPTS (UL transmission in a special subframe) in the special subframe, can also be configured from a set of possible selections.

NR design is based on a flexible structure where any time domain resource for transmission can be allocated for DL or UL or a combination of both. If the DL transmission and UL transmission occur on different carriers, it resembles the FDD type of operation as in LTE. However, if they occur on the same carrier it resembles the TDD type of operation in LTE. Due to the built-in flexible design in NR, the NR operation is sometimes referred to as Dynamic TDD operation. This enables NR to maximally utilize available radio resource in the most efficient way for both traffic directions. The traditional LTE technology only supports static TDD (see section 2.1.3.1 from 36.211 v15.0.0) where time domain resources are split between DL and UL based on a long-term configuration or flexible TDD operation where the changes in the DL and UL configuration can be made only over a period of 5 ms. In contrast, NR is based on the ability to flexibly choose the direction of transmission in periods of 1 ms or less.

Although dynamic TDD brings significant performance gain at low to medium loads, the performance benefits become smaller as the traffic load increases due to the cross-link interference (CLI). As shown in FIG. 1C, if two cells have different traffic directions, UE1 in DL experiences very strong interference from UE2 which can be closer than the serving NN1. From NN2 in UL perspective, NN2 will also experience interference from NN1 since NN1 is transmitting (DL). CLI is the main impediment to performance gains from dynamic TDD operation at higher loads as compared to static TDD. Most solutions to minimize the CLI involve defining signaling between NNs in order to exchange information regarding the sources and the levels of interference in the operator network.

The situation can also be illustrated on symbol level where the different NNs use different transmission directions in different symbols, see FIG. 1D. The situation shown in FIG. 1C occurs in symbol index 3, 4, 10 and 11 in FIG. 1D.

To assist the operator in understanding the pathloss between NNs and UEs, CLI measurements may be adopted. These measurements can be based on for example the total received signal, e.g. Received Signal Strength Indicator (RSSI), or the received signal strength from a specific (set of) transmitting NN/UE, e.g. Received Signal Reference Power (RSRP).

In case the cells of a TDD network are not within the same operator network but in the same geographical area, interference between the operator networks will be present unless also the cells between the networks are synchronized. This applies both in case the networks operate in the same spectrum (co-channel), or are operating in neighbouring spectrum (adjacent-channel).

Synchronization can be achieved by using a common clock to synchronize to (e.g. a GPS) and a common understanding of the TDD configuration used (typically avoiding simultaneous transmission and reception by different cells). Enforcing such a coordination could e.g. be performed on an operator voluntary basis or by regulatory requirements.

However, in case of a dynamically changing DL/UL pattern in the NNs, such coordination will become very complex that may result in a limited or reduced performance of the communication network.

### SUMMARY

An object of embodiments herein is to provide a mechanism for improving performance of the communication network in an efficient manner.

According to an aspect the object may be achieved by a method performed by a first network node for handling communication of data of a first UE in a communication network such as determining TDD configurations for the first UE. The first network node initiates a measurement of interference from a second network node towards the first network node, and/or from a second UE of the second network node towards the first UE of the first network node. The measurement is based on a knowledge of TDD configuration of the second network node. The first network node is operated by a different operator than the second network node. Thus, the second and the first network node may belong to different communications networks such as different operators; the first UE may not be served by the second network node.

According to another aspect the object may be achieved by a method performed by a first UE for handling data in a communication network. The first UE receives a configuration from a first network node, to perform a measurement of interference from a second UE of a second network node, wherein the first network node is operated by a different operator than the second network node. The first UE further performs the measurement of interference from the second UE based on the received configuration.

It is furthermore provided herein a computer program product comprising instructions, which, when executed on at least one processor, cause the at least one processor to carry out any of the methods above, as performed by the first network node or the first UE, respectively. It is additionally provided herein a computer-readable storage medium, having stored thereon a computer program product comprising instructions which, when executed on at least one processor, cause the at least one processor to carry out the method according to any of the methods above, as performed by the first network node or the first UE, respectively.

According to yet another aspect the object may be achieved by providing a first network node for handling communication of data of a first UE in a communication network such as determining TDD configurations for the first UE. The first network node is configured to initiate a measurement of interference from a second network node towards the first network node and/or from a second UE of the second network node towards the first UE of the first network node, wherein the measurement is based on a knowledge of TDD configuration of the second network node. The first network node is operated by a different operator than the second network node

According to still another aspect the object may be achieved by providing a first UE for handling data in a communication network. The first UE is configured to receive a configuration from a first network node, to perform a measurement of interference from a second UE of a second network node, wherein the first network node is operated by a different operator than the second network node. The first UE is further configured to perform the measurement of interference from the second UE based on the received configuration.

Embodiments herein thus enable the first UE or the first network node to perform measurements of interference, also referred to as inter-operator CLI measurements, which allow the first network node or the first UE to estimate the interference impact from other network node or UEs transmitting in neighbouring cells from neighbouring operators. Thus, embodiments herein enable the first network node to perform or control communication based on determined interference of a neighbouring cell or UE, leading to an improved performance of the wireless communication network.

### BRIEF DESCRIPTION OF THE DRAWINGS

Embodiments will now be described in more detail in relation to the enclosed drawings, in which:

FIG. 1A is according to prior art;

FIG. 1B is according to prior art;

FIG. 1C is according to prior art;

FIG. 1D is according to prior art;

FIG. 2A is a schematic overview depicting a communication network according to embodiments herein;

FIG. 2B is a combined flowchart and signalling scheme according to some embodiments herein;

FIG. 2C is a combined flowchart and signalling scheme according to some embodiments herein;

FIG. 2D is a schematic flowchart depicting a method performed by a first network node according to embodiments herein;

FIG. 2E is a schematic flowchart depicting a method performed by a first UE according to embodiments herein;

FIG. 3 is a schematic overview defining CCI and ACI;

FIG. 4 is a diagram depicting carrier leakage measured at a UE from neighbouring operator;

FIG. 5A is a schematic overview depicting a manner to measure interference from a neighbouring UE;

FIG. 5B is a schematic overview depicting a manner to measure interference from a neighbouring network node;

FIG. 6 is a block diagram depicting a first network node according to embodiments herein;

FIG. 7 is a block diagram depicting a first UE according to embodiments herein; and

FIG. 8A shows a telecommunication network connected via an intermediate network to a host computer in accordance with some embodiments;

FIG. 8B shows a host computer communicating via a base station with a user equipment over a partially wireless connection in accordance with some embodiments;

FIG. 9 shows methods implemented in a communication system including a host computer, a base station and a user equipment in accordance with some embodiments;

FIG. 10 shows methods implemented in a communication system including a host computer, a base station and a user equipment in accordance with some embodiments;

FIG. 11 shows methods implemented in a communication system including a host computer, a base station and a user equipment in accordance with some embodiments; and

FIG. 12 shows methods implemented in a communication system including a host computer, a base station and a user equipment in accordance with some embodiments.

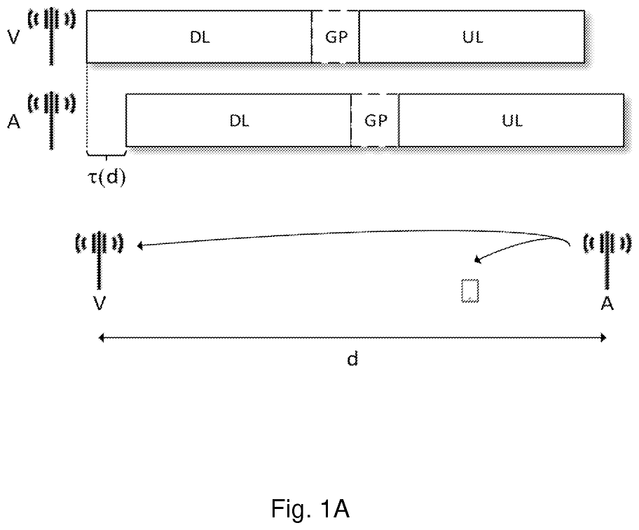

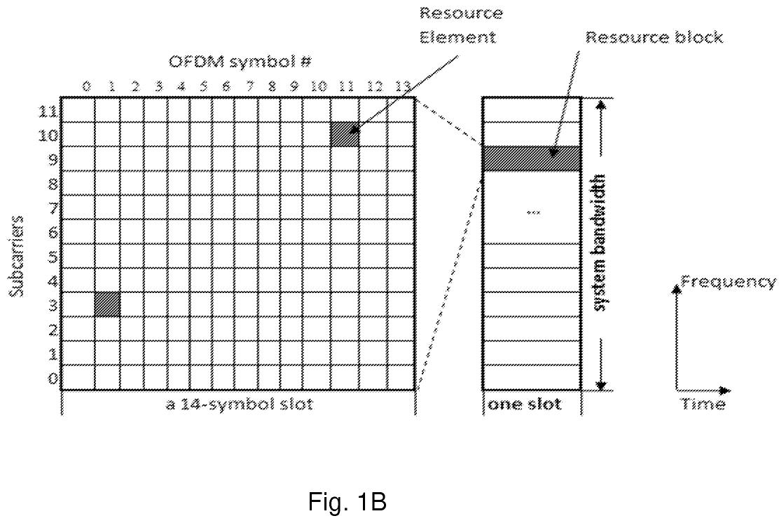

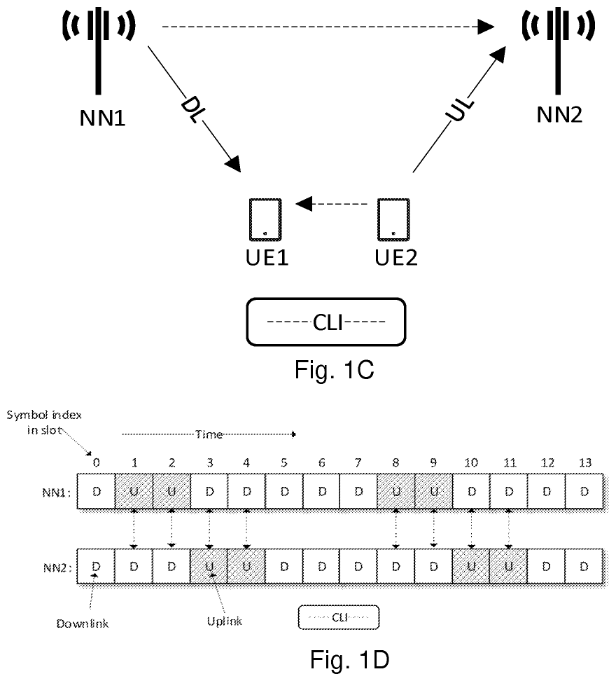

### DETAILED DESCRIPTION

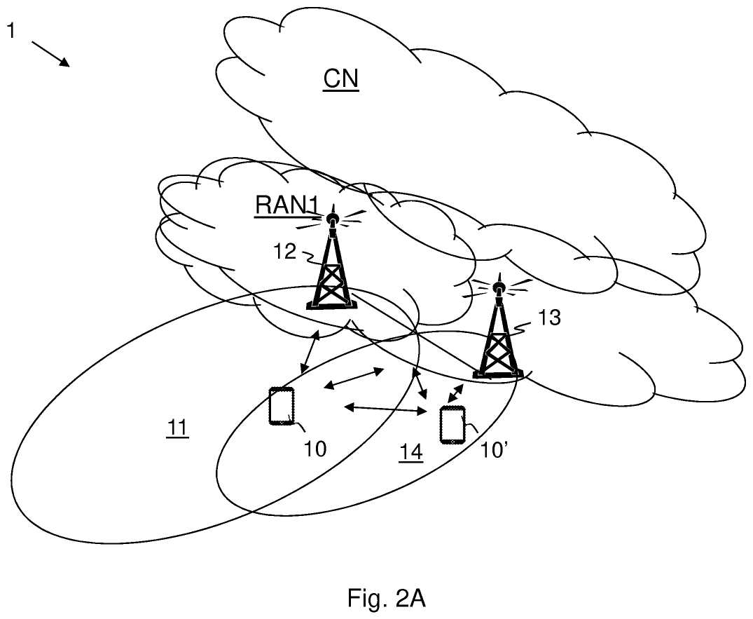

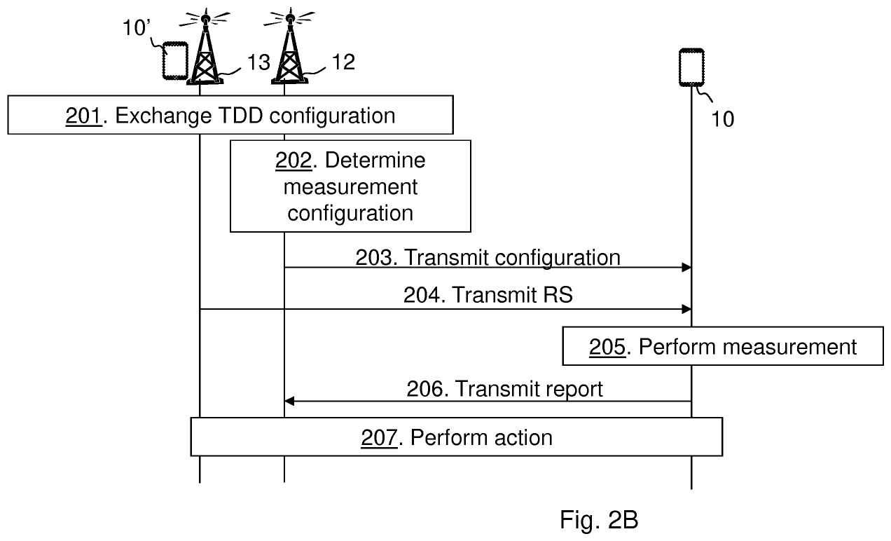

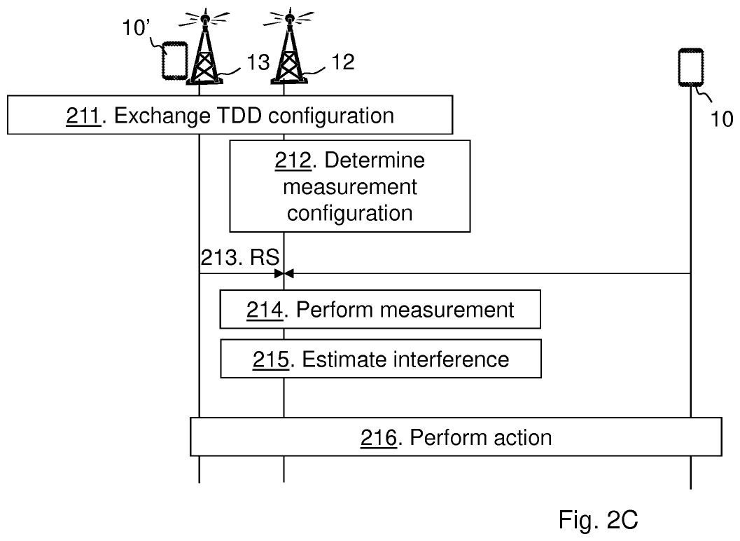

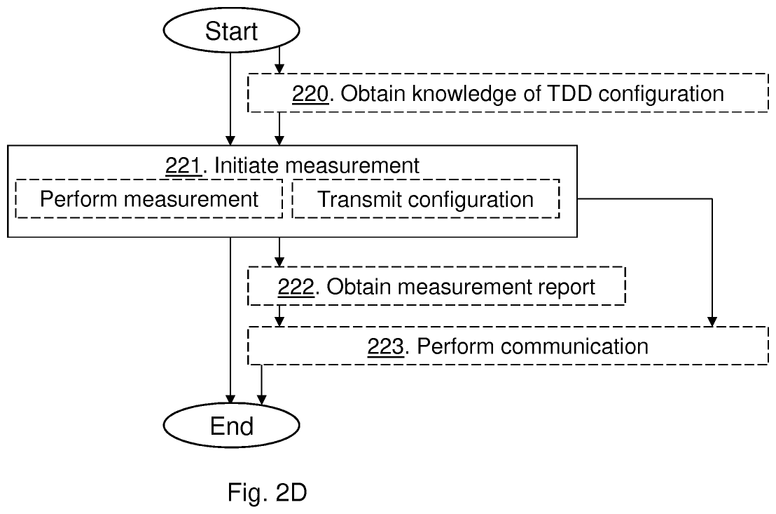

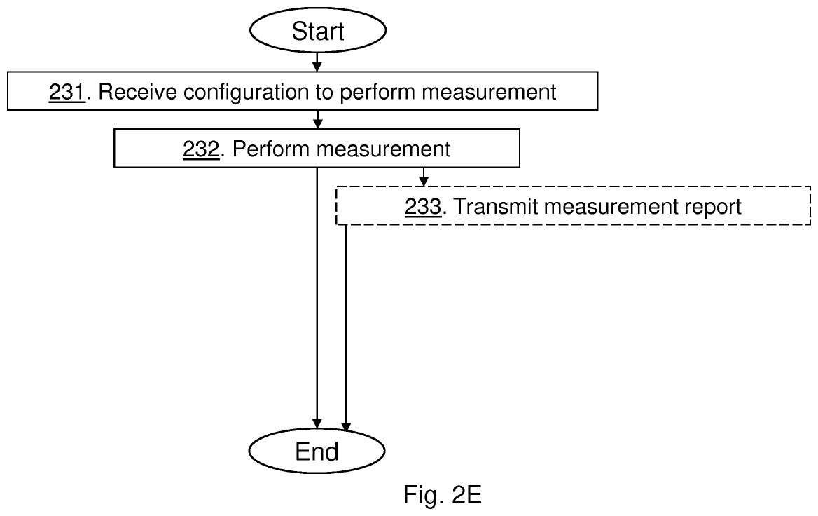

Embodiments herein relate to communication networks in general. FIG. 2A is a schematic overview depicting a communication network 1. The communication network 1 comprises one or more RANs e.g. a first RAN (RAN1), connected to one or more CNs. The communication network 1 may use a number of different technologies, such as Wi-Fi, Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are applicable also in further development of the existing communication systems such as e.g. 3G and LTE.

In the communication network 1, UEs e.g. a first UE 10 such as a mobile station, a non-access point (non-AP) STA, a STA, a wireless device and/or a wireless terminal, are connected via the one or more RANs, to the one or more CNs. It should be understood by those skilled in the art that “UE” is a non-limiting term which means any terminal, wireless communication terminal, user equipment, Machine Type Communication (MTC) device, Internet of Things operable device, Device to Device (D2D) terminal, mobile device e.g. smart phone, laptop, mobile phone, sensor, relay, mobile tablets or any device communicating within a cell or service area.

The communication network 1 comprises a first network node 12 providing radio coverage over a geographical area, a service area 11 or a cell, of a first radio access technology (RAT), such as New Radio (NR), LTE, UMTS, Wi-Fi or similar. The first network node 12 may be a radio access network node or radio network node such as radio network controller or an access point such as a wireless local area network (WLAN) access point or an Access Point Station (AP STA), an access controller, a base station, e.g. a radio base station such as a NodeB, an evolved Node B (eNB, eNodeB), a gNodeB, a base transceiver station, Access Point Base Station, base station router, a transmission arrangement of a radio base station, a stand-alone access point or any other network unit capable of serving a UE within the service area served by the first network node 12 depending e.g. on the first radio access technology and terminology used.

The communication network 1 further comprises a second network node 13 providing radio coverage over a geographical area, a second service area 14 or a second cell, of a second RAT, such as New Radio (NR), LTE, UMTS, Wi-Fi or similar. The second network node 13 may be a radio access network node or radio network node such as radio network controller or an access point such as a wireless local area network (WLAN) access point or an Access Point Station (AP STA), an access controller, a base station, e.g. a radio base station such as a NodeB, an evolved Node B (eNB, eNodeB), a gNodeB, a base transceiver station, Access Point Base Station, base station router, a transmission arrangement of a radio base station, a stand-alone access point or any other network unit capable of serving a UE such as a second UE 10′ within the service area served by the second network node 13 depending e.g. on the second radio access technology and terminology used. The network nodes may by RAN nodes and/or core network nodes e.g. Radio Software Defined Networking (SDN) node, an AMF node, an MME, a S-GW, a Serving GPRS Support Nodes (SGSN) node, or corresponding node in e.g. a 5G network or similar. The GPRS meaning General Packet Radio Services.

In cases herein, neighbouring operators, e.g. different operators of the first and second network node, implement dynamic TDD in the networks, tight coordination between DL and/or UL transmission patterns used is close to infeasible, considering that the change in pattern could depend on the momentary traffic situation in each slot.

According to embodiments herein Inter-operator CLI measurements, i.e. measurements of interference between network nodes or UEs of different communication networks, are introduced which allow a NN or a UE to perform measurements estimating the interference impact from NNs/UEs transmitting in neighbouring cells from neighbouring operators. Embodiments herein facilitate an operator to understand the CLI caused by neighbouring operators.

This can for example be used to:
Coordinate between operators regarding restrictions in dynamic TDD operation for certain cells. For example, coordinate on a set of protected resources where it is known that CLI will not exist, or, to coordinate on a static TDD pattern to apply for the cells with high CLI.
Assist in the radio resource management in the cell if knowing which UEs are potentially interfered by CLI from neighbouring operators.
Detect interference arising from neighbour operators applying dynamic TDD such that appropriate mitigation action can be taken towards the neighbour.

FIG. 2B is a combined flowchart and signalling scheme according to some embodiments herein.

Action 201. The first network node 12 may obtain knowledge of TDD configuration of the second network node 13. E.g. the network nodes may exchange information regarding used TDD configurations.

Action 202. The first network node 12 initiates a measurement of interference, at the first UE 10, from the second network node 13 towards the first network node 12 and/or from the second UE 10′ of the second network node 13 towards the first UE 10, wherein the measurement is based on the knowledge of TDD configuration of the second network node. E.g. the first network node 12 may determine measurement configuration e.g. when and/or at what resources the first UE 10 should perform measurements of interference of the second UE.

Action 203. The first network node 12 may then transmit a configuration to the first UE to perform the measurement of interference.

Action 204. The second network node 13 and/or the second UE 10′ may perform transmissions according to a present TDD configuration, e.g. signalling reference signals.

Action 205. The first UE 10 performs measurements of interference from the second UE (and/or e.g. the second network node, e.g. as configured from the first network node 12 or based on information sent from the first network node 12. E.g. based on measured power.

Action 206. The first UE 10 may then transmit a measurement report from the first UE 10 indicating the measured interference, e.g. level of interference, from the second UE 10′.

Action 207. The first network node 12 may then perform actions based on the measurement report e.g. indicating interference from the second UE 10′. E.g. the first network node 12 may use periods for uplink or downlink communication based on the obtained measurement report. In order to utilize the measurement information, the first network node 12 may be aware of whether the UE measurements relate to DL or UL operation in the neighbour network. In one embodiment, the DL or UL operation in the measured (non-serving) network is known due to synchronization between the networks and knowledge of the DL/UL pattern of the neighbour network.

FIG. 2C is a combined flowchart and signalling scheme according to some embodiments herein.

Action 211. The first network node 12 may obtain knowledge of TDD configuration of the second network node 13. E.g. the network nodes may exchange information regarding used TDD configurations. This corresponds to action 201 above.

Action 212. The first network node 12 initiates a measurement of interference from the second network node 13 of the second network node 13 towards the first network node 12, wherein the measurement is based on the knowledge of TDD configuration of the second network node. E.g. the first network node 12 may determine measurement configuration e.g. when and/or at what resources the first network node 12 should perform measurements of interference of the second network node.

Action 213. The second network node 13, the second UE 10′ and/or the first UE may perform transmissions according to a present TDD configuration, e.g. signalling reference signals in DL of a TDD configuration.

Action 214. The first network node 12 performs measurements of interference from the second network node, e.g. as configured or determined. E.g. based on measured power.

Action 215. The first network node 12 may then generate a measurement report or estimate interference, e.g. level of interference, from the second network node 13 (and/or further from the second UE 10′). E.g. based on measured power. Herein the first network node may determine whether there is an UL configuration or a DL configuration presently at the second network node 13.

Action 216. The first network node 12 may then perform action based on the measurement report e.g. indicating interference from the second network node. E.g. the first network node 12 may use periods for uplink or downlink based on the performed measurements.

The method actions performed by the first network node 12 for handling communication with the first UE, e.g. scheduling UL and/or DL transmission of data of the first UE 10 in the communication network 1 according to embodiments will now be described with reference to a flowchart depicted in FIG. 2D. The actions do not have to be taken in the order stated below, but may be taken in any suitable order. Actions performed in some embodiments are marked with dashed boxes. The second network node 13 may use a same or different frequency than the first network node 12.

Action 220. The first network node 12 may obtain knowledge of TDD configuration of one or more neighbouring network nodes, e.g. exchange TDD configuration information between the network nodes.

Action 221. The first network node 12 initiates the measurement of interference from the second network node 13 towards the first network node 12, and/or from the second UE 10′ of, or served by, the second network node 13 towards the first UE of, or served by, the first network node 12. The measurement is based on the knowledge of TDD configuration of the second network node 13, wherein the first network node is operated by a different operator than the second network node. The interference measured may be an interference of, i.e. caused by, an uplink transmission on a downlink reception, or vice versa, of respective cells. E.g. an uplink transmission from the second UE 10′ causes interference on a downlink reception of the first UE 10, or a downlink transmission of the second network node 13 causes interference on an uplink reception of the first network node 12. Thus, the initialized interference measurement may measure interference of uplink transmission on a downlink reception, or vice versa, of respective cells. The measurement may be performed at the first network node 12. The first network node 12 may initiate the measurement to be done by the first UE 10 by transmitting a configuration to the first UE 10 instructing the first UE 10 to perform the measurement of interference. The configuration may indicate a blanking resource, wherein the blanking resource indicates a resource to perform the measurement of interference, e.g. the blanking resource is a resource upon which the measurement of interference is to be performed.

Thus, the first network node may initiate the measurement of interference from the second network node and/or the second UE 10′ of the second network node 13, wherein the measurement is based on the knowledge of TDD configuration of the second network node 13. The measurement may be performed at the first network node 12, e.g. at a blanking resource. Initiating the measurement may comprise transmitting the configuration to the first UE 10 to perform the measurement of interference. The configuration may indicate the blanking resource, wherein the blanking resource indicates the resource to perform the measurement of interference on.

Action 222. The first network node 12 may obtain the measurement report from the first UE 10 indicating interference from the second UE 10′.

Action 223. The first network node 12 may then perform communication with the first UE 10 based on the obtained measurement report or the performed measurement. E.g. the first network node 12 may perform communication using periods for uplink or downlink based on the obtained measurement report or the performed measurement.

The method actions performed by the first UE 10 for handling communication with the first network node 12, e.g. of data, e.g. in UL and/or DL, in the communication network 1 according to embodiments will now be described with reference to a flowchart depicted in FIG. 2E. The actions do not have to be taken in the order stated below, but may be taken in any suitable order. Actions performed in some embodiments are marked with dashed boxes. The second network node 13 may use a same or different frequency than the first network node 12.

Action 231. The first UE 10 receives the configuration from the first network node 12, to perform the measurement of interference experienced from the second UE 10′ of, e.g. served by, the second network node 13. The first network node is operated by a different operator than the second network node 13. The configuration of the measurement may be based on the knowledge of TDD configuration of the second network node 13. The configuration may indicate the blanking resource, wherein the blanking resource indicates a resource to perform the measurement of interference, e.g. the blanking resource is a resource upon which the measurement of interference is to be performed.

Action 232. The first UE 10 further performs the measurement of interference from the second UE based on the received configuration. The interference measured may be the interference of uplink transmission on the downlink reception, or vice versa, of respective cells. E.g. it may be an uplink transmission, e.g. by the second UE 10′ in a cell served by the second network node 13 that causes interference on a downlink reception, e.g. by the first UE 10 in a cell served by the first network node 12.

Action 233. The first UE 10 may then transmit the measurement report to the first network node 12, wherein the measurement report indicates interference from the second UE at the first UE, i.e. experienced by the first UE.

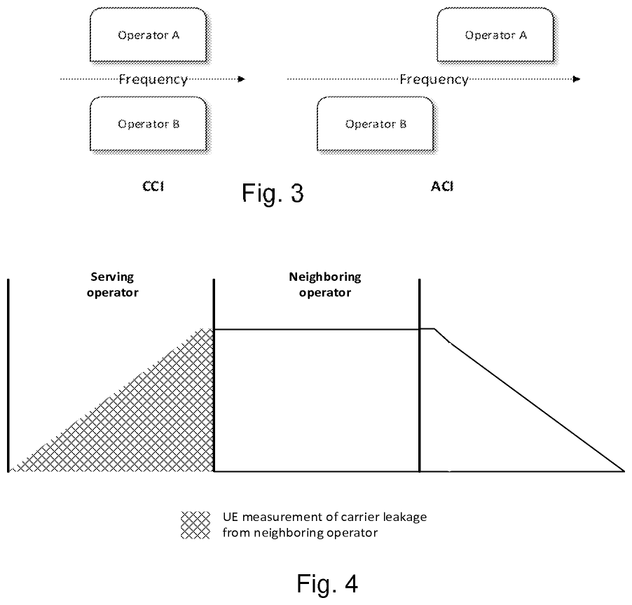

The first UE 10 may according to embodiments herein be configured to measure in one or more time and frequency resource(s) to assist the network node 12 in detecting UE-to-UE interference, where the interfering second UE 10′ belongs to a neighbouring operator, operating in the same geographical area as the serving operator. The allocated spectrum of the two operators can either be the same (co-channel interference (CCI) is caused by the UE), or different (adjacent channel interference (ACI) is caused by the UE), see. FIG. 3. The two possibilities will be referred to as CCI and ACI operation. The CCI scenario may for instance arise from two operators being assigned the same or partially overlapping frequency band in neighbouring countries, i.e. due to inter-border interference (as a spectrum band within a country typically is assigned to a single operator) while the ACI scenario corresponds to a typical inter-operator coexistence scenario within a country's spectrum allocation. The first UE 10 measures on resources belonging to another operator, which the first UE 10 is never to be handed over to. So the intention with the measurement of interference is not to provide mobility opportunities or carrier switching opportunities for the first UE 10 but to supply the first network node 12 with information regarding interference from the second network node 13 or the second UE 10′.

In case of ACI operation, the first UE 10 may be configured to measure on frequency resources different from the frequency resources in the serving cell, wherein the frequency resources to measure on belongs to a neighbouring operator. The frequency resources can for example be another component carrier than that which the first UE 10 is operating on in the serving cell. This may be realized for instance by the first UE 10 being configured with a measurement configuration for inter-frequency measurement on a specific position on a channel raster, for instance being identified by a channel number such as NR Absolute Radio Frequency Channel Number (NR-ARFCN), which are different from the NR-ARFCN of its serving cell. In addition, the first UE 10 may be configured with certain frequency resources relative to the indicated position on the channel raster. This may also include reference signals configurations whereon the first UE 10 is instructed to measure upon.

In case of CCI operation, the first UE 10 is configured to measure on frequency resources in the serving cell, the frequency resources to measure on belonging to both the serving operator and a neighbouring operator.

In case of ACI operation, the first UE 10 may be configured to measure on frequency resources in the serving cell, with the intention to measure the leakage of the neighbouring operator onto the serving operator spectrum. This is exemplified in FIG. 4.

To realize a UE measurement of a neighbouring operator in frequency resources used by the either the neighbouring operator or the serving operator, a blanking of resources may be introduced. The blanking of resources may e.g. be a time resource where the first UE 10 is not expected to receive any DL signals or being scheduled with any UL signals. A blanking of resources may thus allow the first UE 10 to re-tune its radio frequency (RF) oscillator to the neighbouring operators frequency resource and perform a measurement, without worrying about being schedule with DL/UL form the serving operator. I.e. the first UE 10 may use the blanking resource to measure interference from the second network node 13 or the second UE 10′. A blanking resource may thus be introduced which is defined as a certain time resource where the serving operator, i.e. the first network node 12, informs the first UE 10 that the first network node 12 does not intend to transmit anything in the downlink and hence a (potential) dominant interference is expected to come from the neighbouring operator. The blanking resource can be realized through specification (a certain time resource where DL transmissions are not allowed), or by implementation (DL resources are not scheduled in certain time resources where UEs have been configured to measure for inter-operator interference), or by reusing existing specification component in such as the reserved resource framework or zero power (ZP) channel state information reference signal (CSI-RS) configurations. In one embodiment, the blanking resource is configured to occur at certain predefined positions in the frame structure. In another embodiment, the blanking of resources is configured to occur associated with a certain signal transmission, e.g. aligning with a sounding reference signal (SRS) transmission of the neighbouring operator. In another embodiment, the configuration of a blanking resource is explicitly or implicitly associated with the configuration of the CLI measurement. For instance, the first UE 10 may assume according to a predefined rule in specification that DL transmissions from the serving cell do not occur in resources where the first UE 10 has been configured to measure for CLI purposes. Alternatively, whether or not the first UE 10 may assume that other DL signals is present or not is indicated as part of the CLI measurement configuration, for instance using an optionally present radio resource control (RRC) field or boolean RRC field. In another embodiment, the blanking resource is configured to occur in a pseudo random fashion, to avoid collecting interference statistics from only a limited set of time resources, for example only from the last symbol of a slot.

In a scenario where spectrum sharing between two RATs is deployed in the neighbouring network, where the resources for sending control and reference signals of one of the RATs are deterministic (i.e. static and strictly defined by the standard) and thus known to the serving network node 12, the first network node 12 may use this knowledge to infer whether a certain resource in the neighbour network, as well as the corresponding measurement by the first UE 10 refer to DL or UL communication.

The first UE 10 may measure power on both its own channel and the channel of the neighbour network and may estimate an Adjacent Channel Leakage Ratio (ACLR). After estimating the ACLR, the first UE 10 or network node 12 may compare the ACLR to known DL and UL ACLR requirements in order to determine whether the measurement was made during DL or UL in the neighbour network.

The first UE 10 may measure RSRP and RSSI in the neighbour network. If RSRP measurement fails due to the absence of cell specific reference signal (CRS) or other DL reference signals, then the first UE 10 or the first network node 12 may assume that an UL transmission was measured. If the ratio of RSSI to RSRP is larger than a given threshold, the first UE 10 or the first network node 12 may assume that the RSRP is very low due to the absence of detectable CRS or other DL reference signals and that an UL transmission was measured.

A measurement carried out may be performed on a pre-defined frequency resource, the frequency resource covering the complete neighbouring operator allocation, a subset of the neighbouring operator allocation, the complete serving cell operator allocation, or, a subset of the serving cell operator allocation. In one embodiment, multiple measurements can be configured to the first UE 10 to for example cover different frequency resources in the neighbouring operator frequency allocation.

A measurement may be carried out in a specific time resource, the resource being for example a specific time symbol, slot or subframe. In one embodiment multiple measurements can be configured to the first UE 10 to for example get separate measurements for all symbols in a slot. This could for example assist the serving operator, i.e. the first network node 12, to detect the TDD pattern e.g. UL and DL symbols used by the neighbouring operator.

The measurements carried out may be RSSI-based (total signal strength). In another embodiment, the measurements carried out may be RSRP-based (signal strength of a specific signal). In another embodiment, the measurements may be channel quality indicator (CQI)-based (capturing channel characteristics in the measurement). In case of RSRP or CQI-based measurements, the operators may need to coordinate the occasions of the reference signals being transmitted to be able to accurately perform the measurements at the first UE 10.

The CLI measurement reports may be event driven, such that measurements may only be reported when a certain event occurs, such as measurements may only be reported when the measurement quantity exceeds a threshold or the measurement quantity is an offset larger than a reference measurement quantity corresponding for instance to the serving operator cell.

The measurement carried out by the first UE 10 may be performed in different ways, communicating valuable information on the interference situation to the serving operator such as the first network node 12. Embodiments are listed below:
Maximum signal level: The first UE 10 may measure a maximum signal level experienced over the configured time and frequency resources of the measurement.
Average signal level: The first UE 10 may measure the average signal level experienced over the configured time and frequency resources of the measurement.
Variance or standard deviation: The first UE 10 may measure variance or standard deviation to complement the average signal level measurement.
Average fade duration and level crossing rate: The first UE 10 may average fade duration and level crossing rate with respect to a particular signal level.

In case of average signal level is reported, the first UE 10 may perform for instance layer three (L3) filtering of the measurement layer one (L1) quantities which may be realized as an infinite impulse response (IIR) filtering over measurement occasions in time.

It should be noted that the above UE embodiments may also be combined in a same measurement report, i.e. a UE reporting both the maximum and average signal level.

The triggering in time of the UE measurements can be either periodic or aperiodic. The triggering conditions may be pre-defined in a specification, configured by higher layer signaling, e.g. radio resource control (RRC), or, alternatively, triggered dynamically by control signaling in the DL, e.g. using downlink control information (DCI).

The measurement reports from the first UE 10 may be used as follows:

In one embodiment where the first network node 12 is intending to apply a dynamic TDD whilst avoiding interference to the neighbour network, the first network node 12 may consider power measured at the first UE 10 from the neighbour network during uplink periods in the neighbour network. If the measured power is below a predetermined threshold, the first network node 12 may assume that there is no neighbour UE close to the first UE 10. The first network node 12 may then configure the first UE 10 to transmit during downlink periods in the neighbour network, since the first UE 10 is not close to the second UE 10′ and can be assumed not to cause RX interference towards any neighbour second UE receiver;

In one embodiment wherein the first network node 12 may be a victim of interference created due to the neighbour network operating dynamic TDD, the first UE 10 may make measurements of power during periods expected to be DL in the neighbour network. If the measured power is greater than a predetermined threshold, the first network node 12 assumes that it is experiencing interference from the neighbour network due to the neighbour network scheduling UL transmissions during what are expected to be DL periods.

In one embodiment wherein the first network node 12 may be a victim of interference created due to the neighbour network operating dynamic TDD, the first network node 12 may make measurements of power during periods expected to be DL in the neighbour network. Some of the DL periods are known for certain to be used for DL in the neighbour network, whilst other periods may be used for dynamic TDD. The power is compared between known DL periods and periods that may be used for dynamic TDD. If the power during the potential dynamic TDD periods is substantially higher than the power during known DL periods, the first network node 12 may assume that it is experiencing interference from the neighbour network due to the neighbour network scheduling UL transmissions during the periods that may be used for dynamic TDD.

Similar to the UE embodiments above, the first network node 12 can apply similar measurements, such as maximum signal level or average signal level, to identify NN-to-NN interference situations between operators. In one embodiment, the measurements of the NN are specified similarly as for the UE behaviour in the specifications. In another embodiment, the NN behaviour is left up to implementation, i.e. the configuration of measurements, as described in above, will be up to implementation.

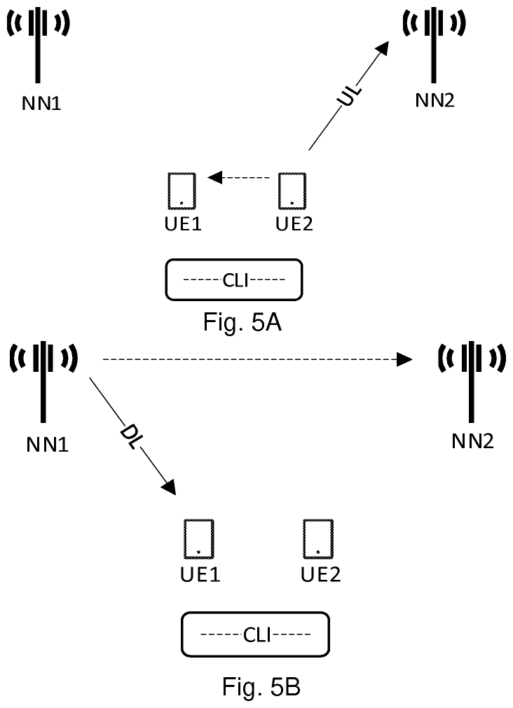

Certain modifications are naturally required to apply the description above to a NN instead of a UE. FIG. 5B provides one example where the blanking of resources in the cell served by NN2 involves UE2 not transmitting on the UL to allow NN2 to measure potential interference from NN1 (compare with FIG. 5A for the UE measurements wherein the blanking of resources in the cell served by NN1 involves no transmission in the cell to allow UE1 to measure potential interference from UE2).

In order to utilize the measurement information, the serving first network node 12 may be aware of whether the network node measurements relate to DL or UL operation in the neighbour network.

In one embodiment, the DL or UL operation in the measured (non-serving) network is known due to synchronization between the networks and knowledge of the DL/UL pattern of the neighbour network.

In one embodiment, in a scenario where spectrum sharing between two RATs is deployed in the neighbouring network, where the resources for sending control and reference signals of one of the RATs are deterministic (i.e. static and strictly defined by the standard) and thus known to the serving network, the serving network can use this knowledge to infer whether a certain resource in the neighbour network, as well as the corresponding measurement by the UE refer to DL or UL communication.

In one embodiment, the network node measures power on both its own channel and the channel of the neighbour network and estimates the Adjacent Channel Leakage Ratio (ACLR), e.g. taking the ratio of a measured power in an adjacent channel and a measured power in a co-channel. After estimating the ACLR, the first network node 12 may compare the ACLR to known DL and UL ACLR requirements in order to determine whether the measurement was made during DL or UL in the neighbour network.

In one embodiment, the first network node 12 may measure RSRP and RSSI in the neighbour network. If RSRP measurement fails due to the absence of CRS or other DL reference signals, then the first network node 12 may assume that an UL transmission was measured. If the ratio of RSSI to RSRP is larger than a given threshold, the first network node 12 may assume that the RSRP is very low due to the absence of detectable CRS or other DL reference signals and that an UL transmission was measured.

The reports from the first network node 12 may be used as follows:

In one embodiment where the first network node 12 is intending to apply dynamic TDD whilst avoiding interference to the neighbour network, the first network node 12 may measure the power at the network node in the neighbour network during DL periods in the neighbour network. If the measured power is below a certain threshold, the first network node 12 may assume that it can use UL periods of the neighbour network to make DL transmissions without causing significant interference towards the neighbour node.

In one embodiment where the first network node 12 may be the victim of interference created due to the neighbour network operating dynamic TDD, the serving first network node 12 may make measurements during periods expected to be DL in the neighbour network. If the measured power is greater than a predefined threshold, then the serving first network node 12 may assume that the neighbour network is in fact using these periods for UL transmissions and is creating interference towards the serving first network node 12.

In one embodiment where the first network node 12 may be the victim of interference created due to the neighbour network operating dynamic TDD, the first network node 12 may make measurements of power during periods known to be DL in the neighbour network and periods that may be used for dynamic TDD in the neighbour network. If the measurements reveal that the received power during the dynamic TDD periods is substantially greater than the received power during the periods known to be DL then the serving first network node 12 may assume that the neighbour network is using the dynamic TDD periods for UL transmissions and is creating interference towards the serving network.

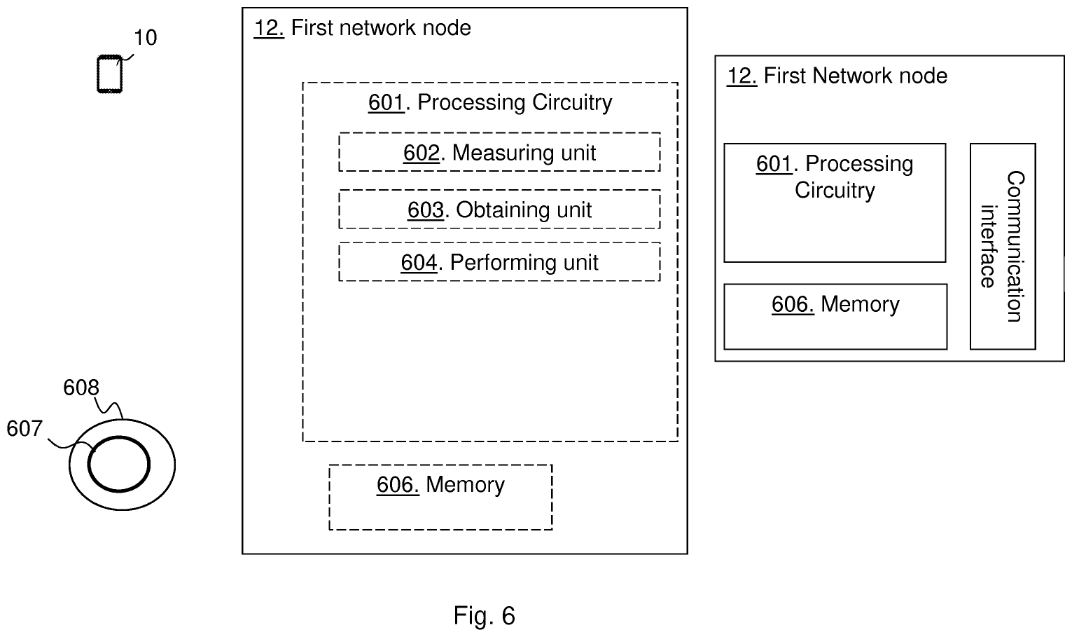

FIG. 6 is a block diagram depicting the first network node 12 in two embodiments for handling communication of data of the first UE 10 in the communication network. The first network node 12 may be configured to use a same or different frequency as the second network node.

The first network node 12 may comprise processing circuitry 601, e.g. one or more processors configured to perform the methods herein.

The first network node 12 may comprise a measuring unit 602. The first network node 12, the processing circuitry 601, and/or the measuring unit is configured to initiate the measurement of interference from the second network node towards the first network node and/or from the second UE 10′ of the second network node 13 towards the first UE of the first network node 12. The measurement is based on the knowledge of TDD configuration of the second network node 13. The first network node is operated by a different operator than the second network node thus the second and first network node may belong to different communications networks or operators. The first UE 10 is not allowed, cannot, be served by the second network node 31. The interference measured may be an interference of uplink transmission on a downlink reception, or vice versa, of respective cells. E.g. it may be an uplink transmission, e.g. by the second UE 10′ in a cell served by the second network node 13 that causes interference on a downlink reception, e.g. by the first UE 10 in a cell served by the first network node 12 or it may be an downlink transmission, e.g. by the second network node 13 in a cell served by the second network node 13 that causes interference on an uplink reception, e.g. by the first network node 12 in a cell served by the first network node 12. The first network node 12, the processing circuitry 601, and/or the measuring unit 602 may be configured to perform the measurement, e.g. on a blanking resource of the first or second network. The first network node 12, the processing circuitry 601, and/or the measuring unit 602 may be configured to initiate the measurement by being configured to transmit the configuration to the first UE to perform the measurement of interference. The configuration may indicate the blanking resource, wherein the blanking resource indicates a resource to perform the measurement of interference.

The first network node 12 may comprise an obtaining unit 603, e.g. a receiver or transceiver. The first network node 12, the processing circuitry 601, and/or the obtaining unit 603 may be configured to obtain the measurement report from the first UE 10 indicating interference from the second UE 10′.

The first network node 12 may comprise a performing unit 604, e.g. a scheduler. The first network node 12, the processing circuitry 601, and/or the performing unit 604 may be configured to perform communication with the first UE 10 based on the obtained measurement report or the performed measurement. The first network node 12, the processing circuitry 601, and/or the performing unit 604 may be configured to perform the communication by using periods for uplink or downlink based on the obtained measurement report or the performed measurement.

The first network node 12 further comprises a memory 606. The memory comprises one or more units to be used to store data on, such as signal strengths or qualities, TDD configurations, measurement configuration, applications to perform the methods disclosed herein when being executed, and similar.

The first network node 12 may further comprise a communication interface such as transmitter, receiver, transceiver and/or one or more antennas.

The methods according to the embodiments described herein for the first network node 12 are respectively implemented by means of e.g. a computer program product 607 or a computer program, comprising instructions, i.e., software code portions, which, when executed on at least one processor, cause the at least one processor to carry out the actions described herein, as performed by the first network node 12. The computer program product 607 may be stored on a computer-readable storage medium 608, e.g. a disc, a universal serial bus (USB) stick or similar. The computer-readable storage medium 608, having stored thereon the computer program product, may comprise the instructions which, when executed on at least one processor, cause the at least one processor to carry out the actions described herein, as performed by the first network node 12. In some embodiments, the computer-readable storage medium may be a transitory or a non-transitory computer-readable storage medium. Thus, the first network node 12 may comprise the processing circuitry and the memory, said memory comprising instructions executable by said processing circuitry whereby said first network node 12 is operative to perform the methods herein.

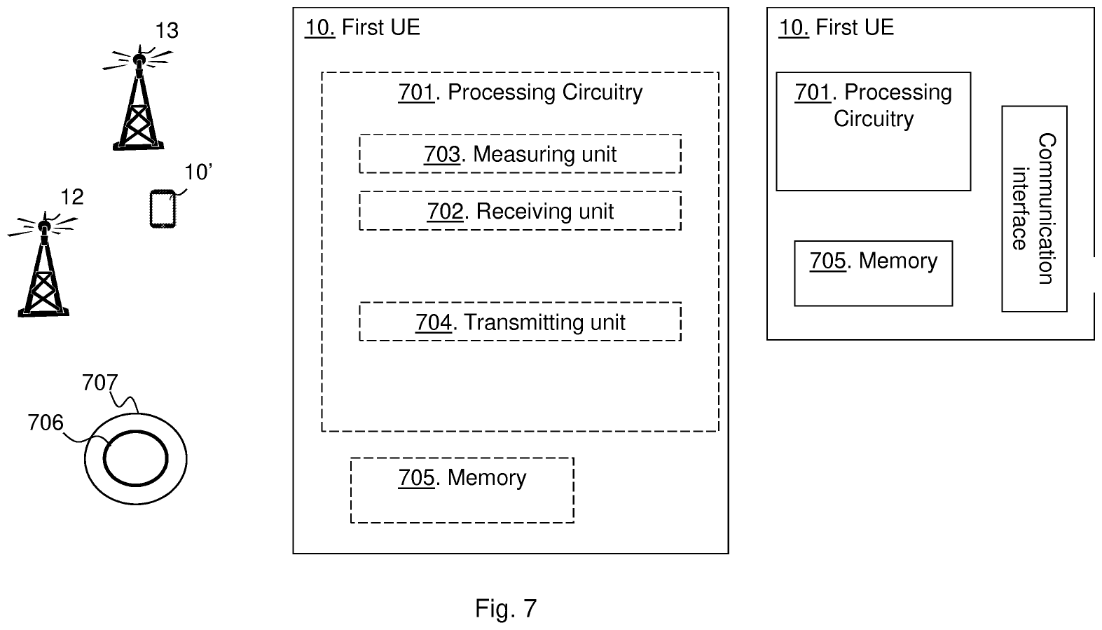

FIG. 7 is a block diagram depicting the first UE 10 for handling data in the communication network 1. The first network node 12 may be configured to use a same or different frequency as the second network node.

The first UE 10 may comprise processing circuitry 701, e.g. one or more processors configured to perform the methods herein.

The first UE 10 may comprise a receiving unit 702, e.g. a receiver or transceiver. The first UE 10, the processing circuitry 701, and/or the receiving unit 702 is configured to receive the configuration from the first network node 12, to perform the measurement of interference from the second UE of the second network node 13 (or from the second network node). The first network node is operated by a different operator than the second network node.

The first UE 10 may comprise a measuring unit 703. The first UE 10, the processing circuitry 701, and/or the measuring unit 703 is configured to perform the measurement of interference from the second UE 10′ based on the received configuration (or from the second network node 13). The interference measured may be the interference of uplink transmission on the downlink reception, or vice versa, of respective cells. The configuration may indicate the blanking resource, wherein the blanking resource indicates a resource to perform the measurement of interference.

The first UE 10 may comprise a transmitting unit 704, e.g. a transmitter or transceiver. The first UE 10, the processing circuitry 701, and/or the transmitting unit 702 may be configured to transmit the measurement report to the first network node, wherein the measurement report indicates interference from the second UE at the first UE 10 (and/or from the second network node 13 at the first UE 10).

The first UE 10 further comprises a memory 705. The memory comprises one or more units to be used to store data on, such as signal strengths or qualities, measurement configurations, configurations, applications to perform the methods disclosed herein when being executed, and similar.

The first UE 10 may further comprise a communication interface such as transmitter, receiver, transceiver and/or one or more antennas.

The methods according to the embodiments described herein for the first UE 10 are respectively implemented by means of e.g. a computer program product 706 or a computer program, comprising instructions, i.e., software code portions, which, when executed on at least one processor, cause the at least one processor to carry out the actions described herein, as performed by the first UE 10. The computer program product 706 may be stored on a computer-readable storage medium 707, e.g. a disc, a universal serial bus (USB) stick or similar. The computer-readable storage medium 707, having stored thereon the computer program product, may comprise the instructions which, when executed on at least one processor, cause the at least one processor to carry out the actions described herein, as performed by the first UE 10. In some embodiments, the computer-readable storage medium may be a transitory or a non-transitory computer-readable storage medium. Thus, the first UE 10 may comprise the processing circuitry and the memory, said memory comprising instructions executable by said processing circuitry whereby said first UE is operative to perform the methods herein.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a radio network node or UE, for example.

Examples of NNs are NodeB, base station (BS), multi-standard radio (MSR) radio node such as MSR BS, eNodeB, gNodeB, MeNB, SeNB, network controller, radio network controller (RNC), base station controller (BSC), road side unit (RSU), relay, donor node controlling relay, base transceiver station (BTS), access point (AP), transmission points, transmission nodes, RRU, RRH, nodes in distributed antenna system (DAS), core NN (e.g. MSC, MME etc), O&M, OSS, SON, positioning node (e.g. E-SMLC) etc.

A UE may refer to any type of wireless device communicating with a NN and/or with another UE in a cellular or mobile communication system. Examples of UE are target device, device to device (D2D) UE, V2X UE, ProSe UE, machine type UE or UE capable of machine to machine (M2M) communication, PDA, iPAD, Tablet, mobile terminals, smart phone, laptop embedded equipped (LEE), laptop mounted equipment (LME), USB dongles etc.

The term time resource used herein may correspond to any type of physical resource or radio resource expressed in terms of length of time. Examples of time resources are: symbol, time slot, subframe, radio frame, TTI, interleaving time, etc.

The term frequency resource used herein may correspond to any type of physical resource or radio resource expressed in terms of span in frequency. A frequency resource need not occupy all physical resource elements in its span.

The term radio access technology, or RAT, may refer to any RAT e.g. UTRA, E-UTRA, narrow band internet of things (NB-loT), WiFi, Bluetooth, next generation RAT (NR), 4G, 5G, etc. Any of the first and the second nodes may be capable of supporting a single or multiple RATs.

The term RS used herein can be any physical signal or physical channel. Examples of DL reference signals are PSS, SSS, CRS, PRS, CSI-RS, DMRS, NRS, NPSS, NSSS, SS, MBSFN RS, RIM RS etc. Examples of UL reference signals are SRS, DMRS etc.

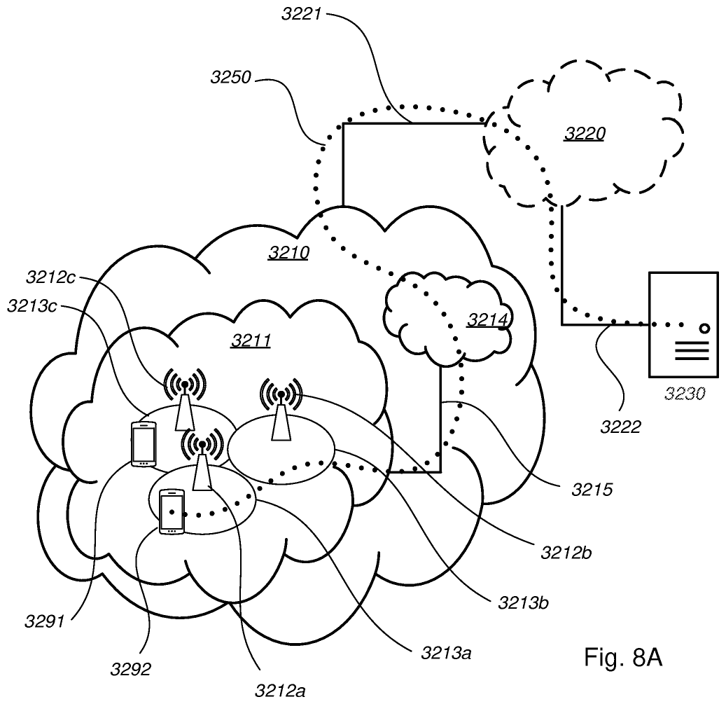

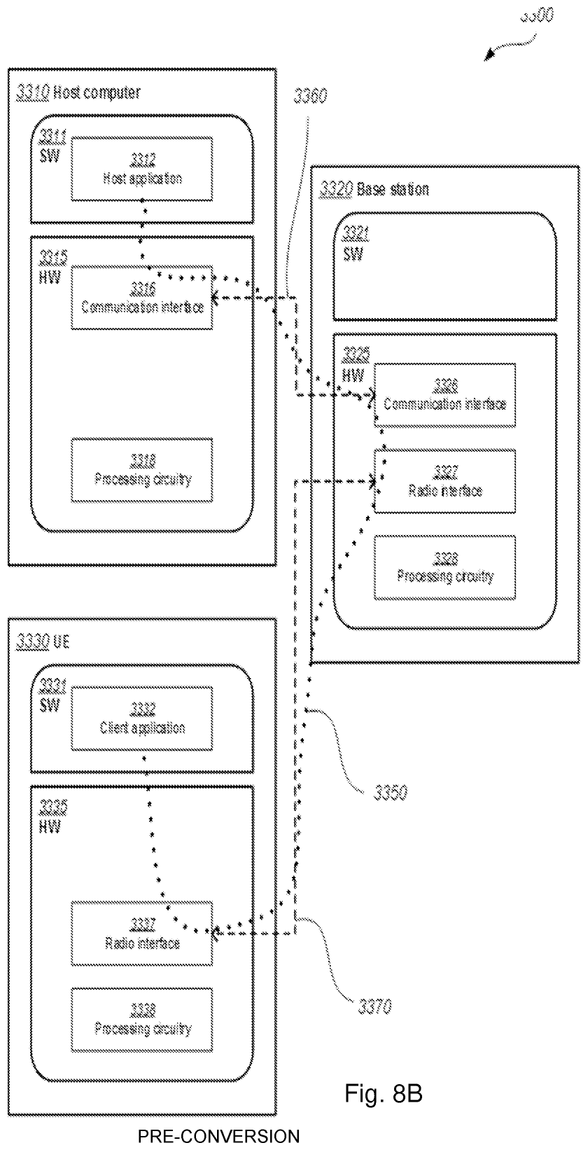

With reference to FIG. 8A, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 8A as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

Example implementations, in accordance with an embodiment, of the UE, base station and host computer discussed in the preceding paragraphs will now be described with reference to FIG. 8B. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8B) served by the base station 3320. The communication interface 3326 may be configured to facilitate a connection 3360 to the host computer 3310. The connection 3360 may be direct or it may pass through a core network (not shown in FIG. 8B) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8B may be identical to the host computer 3230, one of the base stations 3212a, 3212b, 3212c and one of the UEs 3291, 3292 of FIG. 8A, respectively. This is to say, the inner workings of these entities may be as shown in FIG. 8B and independently, the surrounding network topology may be that of FIG. 8A.

In FIG. 8B, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the latency since interference is reduced during communication and thereby provide benefits such as reduced waiting time and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

FIG. 9 is a flowchart illustrating a method implemented in a communication system, in accordance with one embodiment. The communication system includes a host computer, a base station and a UE which may be those described with reference to FIGS. 8A and 8B. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

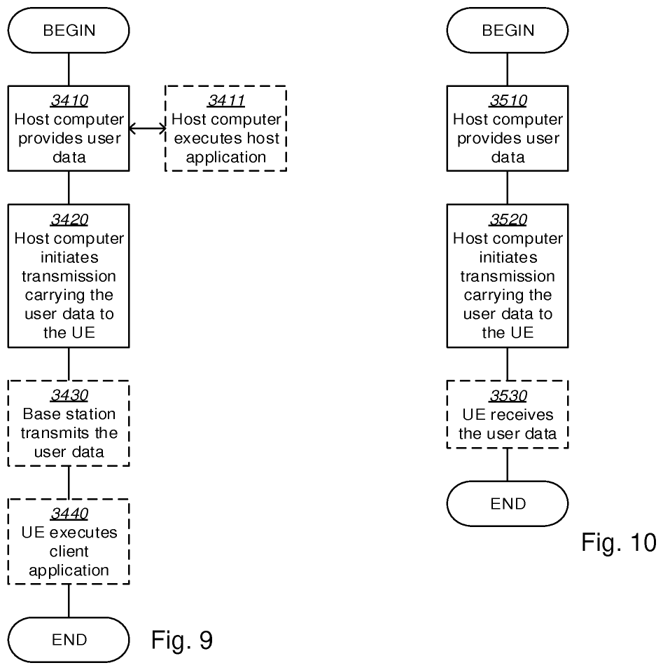

FIG. 10 is a flowchart illustrating a method implemented in a communication system, in accordance with one embodiment. The communication system includes a host computer, a base station and a UE which may be those described with reference to FIGS. 8A and 8B. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

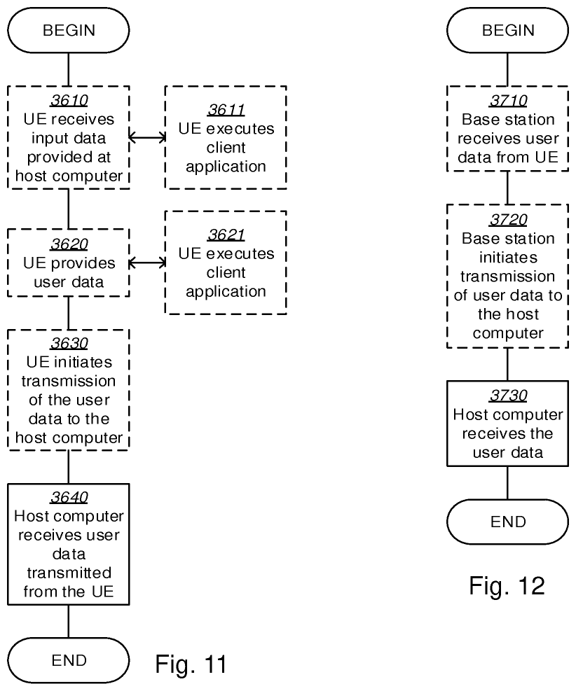

FIG. 11 is a flowchart illustrating a method implemented in a communication system, in accordance with one embodiment. The communication system includes a host computer, a base station and a UE which may be those described with reference to FIGS. 8A and 8B. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 8A and 8B. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

First embodiment: a method performed by a first network node 12 for handling communication of data of a first user equipment, UE, 10 in a communication network, the method comprising
initiating (221) a measurement of interference from a second network node and/or a second UE 10′ of the second network node 13, wherein the measurement is based on a knowledge of time division duplex, TDD, configuration of the second network node.

The method according to the first embodiment, wherein the measurement is performed at the first network node 12.

The method according to any of the first embodiment, wherein initiating the measurement comprises transmitting a configuration to the first UE to perform the measurement of interference.

The method according to the first embodiment, wherein the configuration indicates a blanking resource, wherein the blanking resource indicates a resource to perform the measurement of interference.

The method according to any of the first embodiment, further comprising
obtaining (222) a measurement report from the first UE 10 indicating interference from the second network node and/or the second UE.

The method according to any of the first embodiment, further comprising
performing (223) communication with the first UE based on the obtained measurement report or the performed measurement.

The method according to any of the first embodiment, wherein performing the communication comprises using periods for uplink or downlink based on the obtained measurement report or the performed measurement.

The method according to any of the first embodiment, wherein the second network node uses a same or different frequency than the first network node.

Second embodiment: A method performed by a first user equipment 10 for handling data in a communication network, the method comprising
receiving (231) a configuration from a first network node 12, to perform a measurement of interference from a second network node or a second UE of the second network node; and
performing (232) the measurement of interference from the second network node or the second UE based on the received configuration.

The method according to the second embodiment, wherein the configuration indicates a blanking resource, wherein the blanking resource indicates a resource to perform the measurement of interference.

The method according to the second embodiment, further comprising
transmitting (233) a measurement report to the first network node, wherein the measurement report indicates interference from the second network node and/or the second UE at the first UE.

Third embodiment: A first network node 12 for handling communication of data of a first user equipment, UE, 10 in a communication network, wherein the first network node is configured to
initiate a measurement of interference from a second network node and/or a second UE (10′) of the second network node (13), wherein the measurement is based on a knowledge of time division duplex, TDD, configuration of the second network node.

The first network node according to the third embodiment, wherein first network node 12 is configured to perform the measurement.

The first network node according to any of the third embodiments, wherein the first network node 12 is configured to initiate the measurement by being configured to transmit a configuration to the first UE to perform the measurement of interference.

The first network node according to the third embodiment, wherein the configuration indicates a blanking resource, wherein the blanking resource indicates a resource to perform the measurement of interference.

The first network node according to any of the third embodiments, wherein the first network node 12 is further configured to obtain a measurement report from the first UE 10 indicating interference from the second network node and/or the second UE.

The first network node according to any of the third embodiments, wherein the first network node 12 is further configured to perform communication with the first UE based on the obtained measurement report or the performed measurement.

The first network node according to any of the third embodiments, wherein the first network node 12 is further configured to perform the communication by using periods for uplink or downlink based on the obtained measurement report or the performed measurement.

The first network node according to any of the third embodiments, wherein the first network node is configured to use a same or different frequency as the second network node.

A fourth embodiment: A first user equipment 10, UE, for handling data in a communication network, wherein the first UE is configured to:
receive a configuration from a first network node 12, to perform a measurement of interference from a second network node or a second UE of the second network node; and
perform the measurement of interference from the second network node or the second UE based on the received configuration.

The first UE according to the fourth embodiment, wherein the configuration indicates a blanking resource, wherein the blanking resource indicates a resource to perform the measurement of interference.

The first UE according to any of the fourth embodiments, wherein the first UE 10 is further configured to transmit a measurement report to the first network node, wherein the measurement report indicates interference from the second network node and/or the second UE at the first UE.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method performed by a first network node for handling communication of data of a first user equipment, UE, in a communication network, the method comprising
initiating a measurement of interference from a second network node towards the first network node, and/or from a second UE of the second network node towards the first UE of the first network node, wherein the measurement is based on a knowledge of time division duplex, TDD, configuration of the second network node, and wherein the first network node is operated by a different operator than the second network node.

2. The method according to the claim 1, wherein the interference measured is an interference of uplink transmission on a downlink reception, or vice versa, of respective cells.

3. The method according to claim 1, wherein the measurement is performed at the first network node.

4. The method according to claim 1, wherein initiating the measurement comprises transmitting a configuration to the first UE to perform the measurement of interference.

5. The method according to the claim 4, wherein the configuration indicates a blanking resource, wherein the blanking resource indicates a resource to perform the measurement of interference.

6. The method according to claim 1, further comprising
obtaining a measurement report from the first UE indicating interference from the second UE.

7. The method according to the claim 6, further comprising
performing communication with the first UE based on the obtained measurement report or the performed measurement.

8. The method according to the claim 7, wherein performing the communication comprises using periods for uplink or downlink based on the obtained measurement report or the performed measurement.

9. The method according to claim 1, wherein the second network node uses a same or different frequency than the first network node.

10. A method performed by a first user equipment, UE, for handling data in a communication network, the method comprising
receiving a configuration from a first network node 12, to perform a measurement of interference from a second UE of a second network node, wherein the first network node is operated by a different operator than the second network node; and
performing the measurement of interference from the second UE based on the received configuration.

11. The method according to the claim 10, wherein the interference measured is an interference of uplink transmission on a downlink reception, or vice versa, of respective cells.

12. The method according to claim 10, wherein the configuration indicates a blanking resource, wherein the blanking resource indicates a resource to perform the measurement of interference.

13. The method according to claim 10, further comprising
transmitting a measurement report to the first network node, wherein the measurement report indicates interference from the second UE at the first UE.

14. A first network node for handling communication of data of a first user equipment, UE, in a communication network, wherein the first network node is configured to
initiate a measurement of interference from a second network node towards the first network node, and/or from a second UE of the second network node towards the first UE of the first network node, wherein the measurement is based on a knowledge of time division duplex, TDD, configuration of the second network node, and wherein the first network node is operated by a different operator than the second network node.

15. The first network node according to the claim 14, wherein the interference measured is an interference of uplink transmission on a downlink reception, or vice versa, of respective cells.

16. The first network node according to claim 14, wherein first network node is configured to perform the measurement.

17. The first network node according to claim 14, wherein the first network node is configured to initiate the measurement by being configured to transmit a configuration to the first UE to perform the measurement of interference.

18. The first network node according to the claim 17, wherein the configuration indicates a blanking resource, wherein the blanking resource indicates a resource to perform the measurement of interference.

19. The first network node according to claim 14, wherein the first network node is further configured to obtain a measurement report from the first UE indicating interference from the second UE.

20. The first network node according to claim 14, wherein the first network node is further configured to perform communication with the first UE based on the obtained measurement report or the performed measurement.

21. The first network node according to claim 14, wherein the first network node is further configured to perform the communication by using periods for uplink or downlink based on the obtained measurement report or the performed measurement.

22. The first network node according to claim 14, wherein the first network node is configured to use a same or different frequency as the second network node.

23. A first user equipment, UE, for handling data in a communication network, wherein the first UE is configured to:
receive a configuration from a first network node, to perform a measurement of interference from a second UE of a second network node, wherein the first network node is operated by a different operator than the second network node; and
perform the measurement of interference from the second UE based on the received configuration.

24. The first UE according to the claim 23, wherein the interference measured is an interference of uplink transmission on a downlink reception, or vice versa, of respective cells.

25. The first UE according to claim 23, wherein the configuration indicates a blanking resource, wherein the blanking resource indicates a resource to perform the measurement of interference.

26. The first UE according to claim 23, wherein the first UE is further configured to transmit a measurement report to the first network node, wherein the measurement report indicates interference from the second UE at the first UE.

27. (canceled)

28. (canceled)
